(19) United States
(12) Patent Application Publication
(10) Pub. No.: US 2005/0011681 A1
(43) Pub. Date: Jan. 20, 2005

(54) Flexible weighing device

(76) Inventor: Stephane Andre Follonier, Dublin, CA (US)

Correspondence Address: STEPHANE FOLLONIER, APT. B, 7306 PARKWOOD CR., DUBLIN, CA, 94568, US

(21) Appl. No.: 10/620,500

(22) Filed: Jul. 16, 2003

(51) Int. Cl. G01G 3/14; G01G 23/38

(52) U.S. Cl. 177/10

(57) ABSTRACT

The present invention provides a flexible weighing device, which can be folded and/or rolled into any shape. It comprises at least one measuring cell that induces an electrical signal proportional to its deformation. From the overall weight applied to the weighing device, the overall signal is computed and then displayed. The assembly is made flexible through the use of either a single flexible measuring cell or a multiplicity of measuring cells held together through flexible connectors. The flexible weighing device may also yield instantaneously the position and weight of moving objects.

### BACKGROUND OF THE INVENTION

REFERENCES CITED BY THE INVENTOR

| | | | |
|---|---|---|---|
| 4,711,313 | Dec. 8, 1987 | lida; Hiroyuki et al. | 177/127 |
| 4,794,365 | Dec. 27, 1988 | Dunbar; John H. | 338/99 |
| 4,800,973 | Jan. 31, 1989 | Angel; Shlomo | 177/211 |
| 4,845,457 | Jul. 4, 1989 | Nakanishi; Motoyasu | 338/114 |
| 4,957,178 | Sep. 18, 1990 | Mills; Nigel G. | 177/134 |
| 5,036,306 | Jul. 30, 1991 | Bergkvist; Lars A. | 338/114 |
| 5,234,065 | Nov. 23, 1992 | Schmidt; Karl B. | 177/209 |
| 5,168,945 | Dec. 8, 1992 | Byers; Edward V. | 177/225 |
| 5,393,935 | Jul. 9, 1993 | Hasty; Byron E. et al. | 177/45 |
| 5,986,221 | Nov. 16, 1999 | Stanley; James G. | 177/136 |
| 6,346,680 | Feb. 12, 2002 | Takahashi et al. | 177/1 |

The known weighing devices have a hard, non-flexible base and/or top, which limits them as follows:
i) portability is limited through the weight and size required by the hard, non-flexible base and/or top, especially in applications involving weighing large objects such a animals/cars/trucks/planes;
ii) foldability is limited through the required hard, non-flexible base and/or top that prevents, for example, the weighing device to be rolled and stored in a cylinder shape container;
iii) convenience is limited through the lack of robustness (sensitivity to rough handling), the limited use (sensitivity to chemicals), the size (storage/handling), and the weight (handling) of the weighing device;
iv) freedom of design is limited through the limited shapes, sizes and materials allowed by the hard, non-flexible base and/or top, especially for person weighing devices and/or food weighing devices.

In terms of precision, most the known weighing devices rely on measuring a change of separation distance between top and base plates. Shear forces between the top and the base will therefore induce loss of precision in those weighing devices.

### BRIEF SUMMARY OF THE INVENTION

The present invention is directed to flexible weighing devices. Flexibility is achieved by either making the measuring cell flexible or by splitting the measuring cells into multiple sub-measuring cells, which may be flexibly connected, through a flexible packaging material. In either case the overall weighing device is flexible. On top of making them easy to store and/or to carry, the flexibility also allows diverse usages, which could not be accomplished with the known weighing devices. For example uses such as portable truck, car, plane weighing devices are possible with the present invention. In this particular example, a separate sizable weighing device could be used under each tire, and the overall weight could then be computed.

In one of aspect this invention is directed to a flexible weighing device comprising at least one measuring cell, which cell yields an electrical signal proportional to its deformation; a processing circuitry, which circuitry computes the overall signal resulting from the electrical signal from the at least one measuring cell; and a display, which shows the overall signal computed by the processing circuitry.

The measuring cell or cells may be flexible or non-flexible or a combination of flexible and non-flexible cells. These cells may be flexibly connected. The connections and devices of the processing circuitry may use cables, wireless connections or a combination of both cable and wireless connections.

The display maybe an audio display or a visual display and may be flexible.

The display and the processing circuitry may each independently be integrated or separated from the weighing device itself.

The measuring cell may be constructed of a flexible resistive elastomer, which may optionally be embedded in a flexible insulating elastomer. The measuring cell may be constructed of a 1-dimensional (semi-)conductive elastomer. The measuring cell may alternatively be constructed of a piezo-resistive sensor. In another aspect of this invention the weighing device may be comprised of more than one measuring cell. The individual measuring cells may be made of the same or different materials.

The measuring cells may be flexibly connected by, for example, a flexible insulating elastomer.

In another aspect the flexible weighing device has a measuring cell that provides an instantaneous signal that is proportional to its deformation.

In one of its method aspects the present invention is directed to a method for measuring the weight of a moving object, said method comprising providing on a surface a flexible weighing device as described herein, wherein said measuring cell provides an instantaneous signal that is processed by the processing circuitry and shown on the display; moving said object over the flexible weighing device in a manner sufficient to allow the measuring cell to deform; and reading the weight calculated by the processing circuitry and shown on the display.

In addition the present invention makes possible a thin weighing scale (much less than 1 inch) that could be rolled for either storage or transportation for use as a baby weighing device, for example. Thin weighing devices may also be used in food trays as integrated sensors, or even as bathroom carpet with integrated sensors. They could be incorporated into more complex devices/apparatus/manufacturing lines, e.g. in food packaging processing lines. Due to the fast acquisition of the signal, even moving objects could be weighed opening new domains of applications such as scales for animals.

One object of the present invention is to provide a new and improved weighing device that is flexible allowing more convenient transport/storage/usage and more freedom in design/integration.

The device of the present invention provides various degrees of complexity and/or precision of weighing devices to cover multiple orders of magnitude of weighing objects with various grades of weighing precisions and acquisition speeds.

The device of the present invention may incorporate various existing deformation sensors in to the weighing device to attain various deformation precision measurements and/or various deformation magnitude measurements. Examples of deformation sensors are piezoelectric, resistive, capacitive, inductive sensors.

The device of the present invention comprises a processing circuitry that computes overall deformation with corrections (e.g. non-linearity) steming from separate deformations of multiple measuring cells. The processing circuit is designed to enhance the overall sensitivity of the weighing device by allowing to compute only differences with respect to the starting electrical signal. The processing circuitry also sends the calculated weight to the display using cable or wireless connections.

The device of the present invention comprises a visual display that could be either separated from the deformation sensor(s) and addressed by IR signal, for example, or that could be part of the flexible scale using flexible visual display integrated in the flexible weighing device.

### BRIEF DESCRIPTION OF THE SEVERAL VIEWS OF THE DRAWING

FIG. 1: Measuring cell with one sensor and two electrodes

FIG. 2: Measuring cell with one sensor and multiple electrodes

FIG. 3: Measurig cell with one sensor and multiple electrodes

FIG. 4: Measuring cell with multiple sensors and multiple electodes

FIG. 5: Measuring cell with multiple sensors and two electodes

FIG. 6: Measuring cell with multiple sensors and multiple electrodes

FIG. 7: Weighing device with multiple sensors and multiple electrodes connected through cable transmission

### DETAILED DESCRIPTION OF THE INVENTION

The following detailed description illustrates the invention by way of example and is not intended to limit the scope of the claimed invention. This description will clearly enable one skilled in the art to make and use the invention, and describes several embodiments, adaptations, variations, alternatives and uses of the invention, including what we presently believe is the best mode of carrying out the invention.

Besides lifting the constraints of the known weighing devices, the flexible weighing device approach offers several technical advantages. Flexible weighing devices can be matched and adapted instantaneously to the shape of the underlying surface, as in convey bells in production lines. The flexibility in the weighing sensor design allows instantaneous (sub-seconds) readings of the weight and/or position of the object allowing measurement of moving objects. In addition, the flexible multiple sensors approach reduces the influence of shear/lateral forces enhancing the precision of the weighing devices in extreme cases such as moving object.

The Measuring Cell(s)

The measuring cell(s) may be comprised of any apparatus that produces an electrically measurable change upon deformation (e.g. a change in resistance/capacitance/inductance). The choice of the measuring cell(s) is not limited to a specific design and is determined by the need of the application, e.g. its price, its lifetime, its working range and/or its precision. Examples of such measuring cells that may be used in the present invention are
i) piezo-resistive sensor measuring cells (based on materials that produce a change of resistivity upon pressure)
ii) semi-conductive elastomer measuring cells (based on elastomers doped with specific fillers to induce a specific semi-conductivity)
iii) One-dimensionally semi-conductive elastomer measuring cells (based on elastomers that are semi-conductive along one direction only (used to limit the influence of shear forces))

The measuring cell(s) may be comprised of two embodiments with different functions, the first ensuring the very linear dependence of the deformation with pressure and the second of much lower hardness ensuring the linearity of the electrical signal upon deformation.

The Processing Circuitry

The processing circuitry useful in this invention is well-known in the art. It comprises of the electric traces between at least one measuring cell as well as the board processing unit that computes the overall signal from the electrical signal and finally sends the final computed weight to the display. The electrical traces may be flexible and their design is determined by the need of the application. The board processing unit may be flexible and may be integrated into the base unit comprising of at least one measuring cell(s) or it may be separate and addressed through cable or wireless signals. The board processing unit may integrate memory or/and additional functionality such a weight and/or calories depending upon the ultimate use of the particular weighing device. The electronics, depending on the design and use of the weighing device may
i) correct for any non-linearity of each measuring cell individually or as an ensemble,
ii) zero the overall signal electrically (through resistors) or electronically (through IC) to allow the sensing of only changes from a given starting value,
iii) compute the weight from any type of input signal with a predefined lookup table.

The Display

The audio or visual display, that may be integrated or separate from the weighing device base unit, serves as an interface to the user. It may be configured to receive inputs from the user and/or display information to the user. It may be flexible (E Ink Corporation, Cambridge Mass.) or fragmented into small pieces to preserve the overall flexibility of the weighing device. One of ordinary skill in the art would know how to chose the appropriate display for the specific weighing device, taking into consideration, for example, the overall wattage such that the energy consumption remains low. The display may include other functionality such as screen saver or memory.

The Weighing Device Comprising One Flexible Unique Measuring Cell

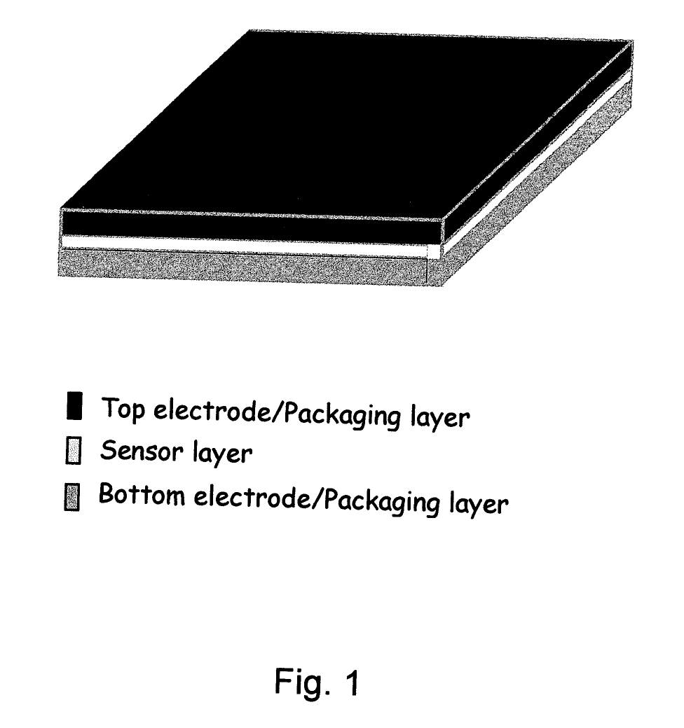

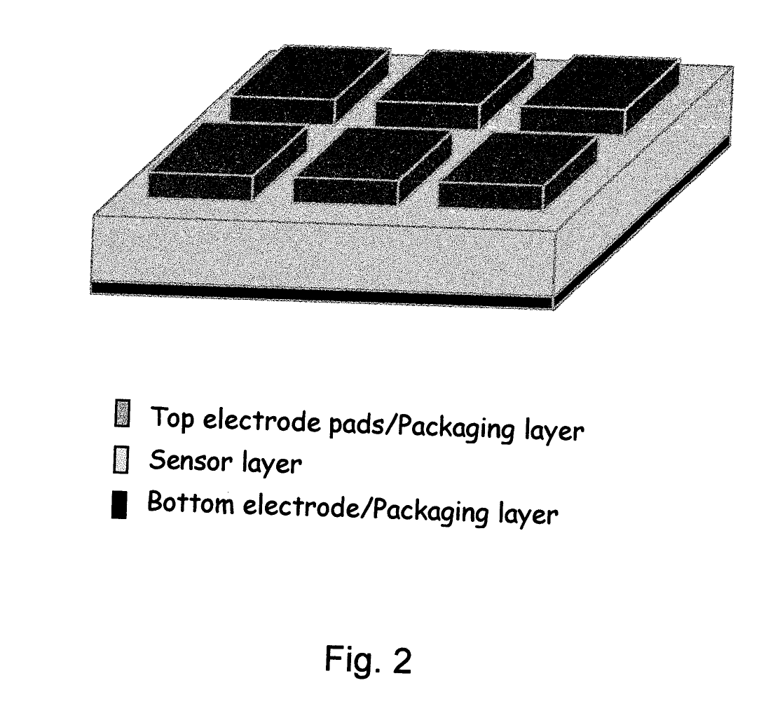

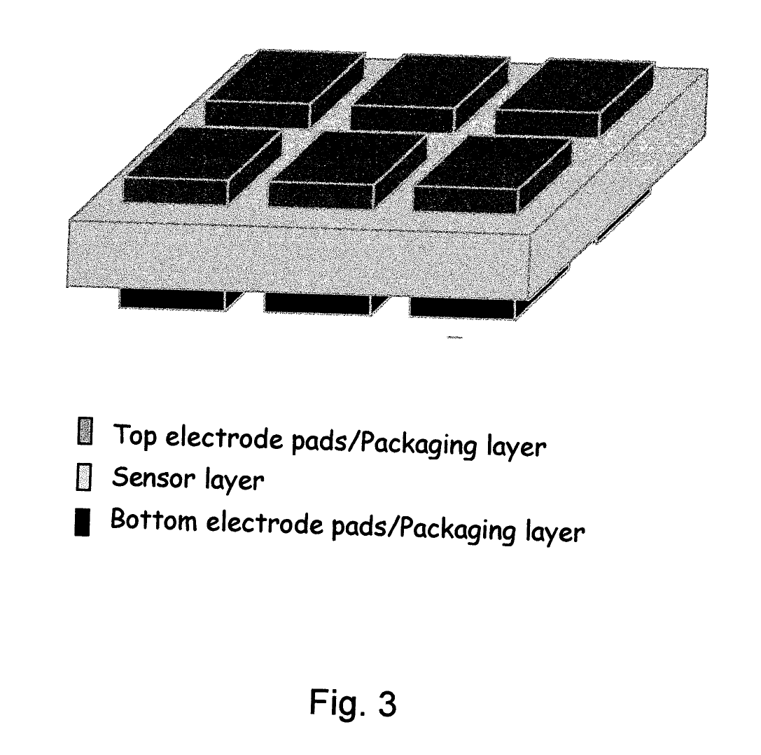

The weighing device comprises the one flexible measuring cell, the processing circuitry and the display. Possible arrangements of the measuring cell are depicted in the FIGS. 1-3. First, if the device is comprised of a flexible unique measuring cell, this measuring cell may be sandwiched between a top and a bottom electrode plane as shown in FIG. 1 or between multiple top and/or bottom electrodes as shown on FIGS. 2 and 3 connected through the processing circuitry. The total deformation is proportional to the change of resistivity/capacity/inductance of the measuring cell. This electrical signal is then further processed through the board processing unit to yield the overall signal.

In practice, the following detailed description of a person weighing device illustrates the invention by way of example and not by way of limitation: The measuring cell is made out of an elastomer filled with conductive metallic particles in order to obtain the proper overall resistance to both limit the power consumption of the weighing device (1 Volt battery powered weighing device) and to produce a detectable current change under deformation (MPC, Cranston, R.I. 02921-3403 USA). The hardness of the material is chosen upon the application, e.g. for a person weighing device, the material under compression may yield a 25% compression for 200 lbs (Note that non-linearities may be corrected through the processing circuitry (memorized lookup table)). The overall resistance is chosen as R=100'000 ohms. The elastomer is covered (top and bottom) with a conductive flexible coating to form the two contact electrodes (M.G. Chemicals, Toronto, Ontario, Canada). The 1 volt battery induces a current of 10 microamperes flowing through the elastomer (the measuring cell). The processing circuitry is made out of a Wheatstone bridge that provides a gain in sensitivity by measuring the change in the resistance (around R=100'000 ohms) under deformation (weighing device): a compensating potentiometer is used to reset the signal on the display prior to a measurement so that only changes to the overall resistance are measured.

For a deformation induced change of resistance of the measuring cell/flexible elastomer (when a person stands on the weighing device), the flexible elastomer undergoes a deformation proportional to the weight of the person, the change of current induced between the top and bottom electrodes at fixed applied voltage being proportional to the deformation. The overall signal can then be computed indicating the weight of the person on the visual display.

The Weighing Device Comprising Multiple Flexible Measuring Cells

For flexible weighing devices comprising multiple measuring cells, i.e. flexibly connected measuring cells, the measuring cells are connected either through a flexible packaging material (MPC, Cranston, R.I. 02921-3403 USA) or through the processing circuit (either through electrical traces or cables or wireless transmission) or both.

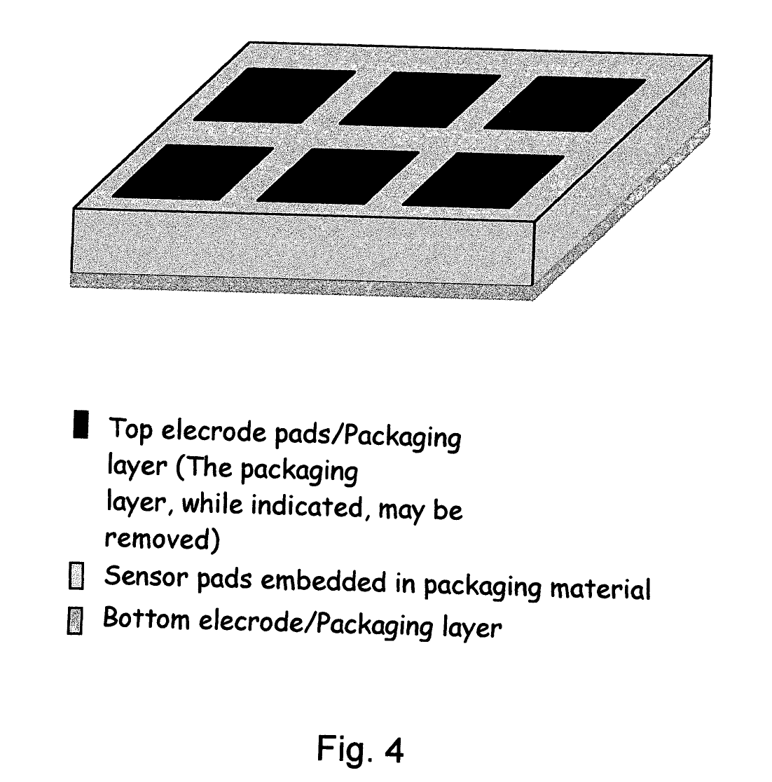

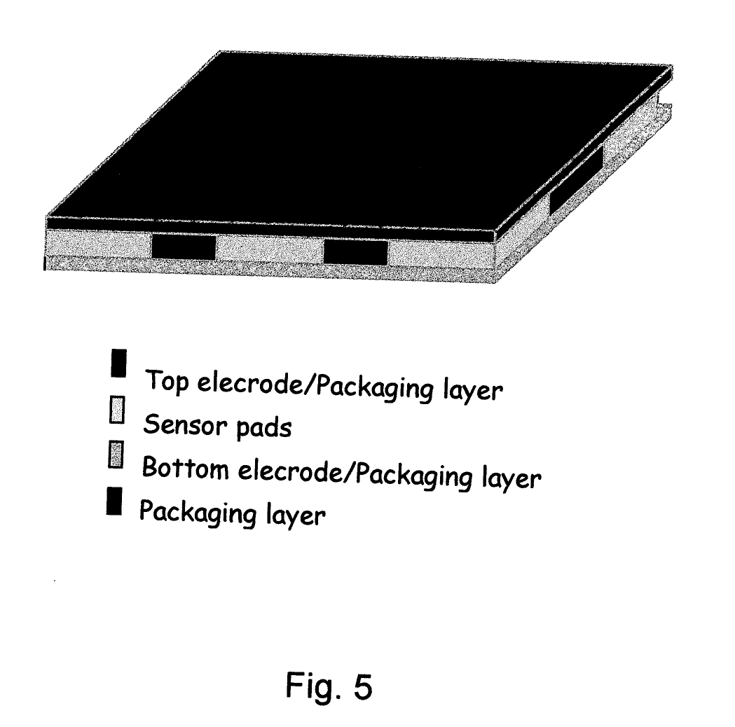

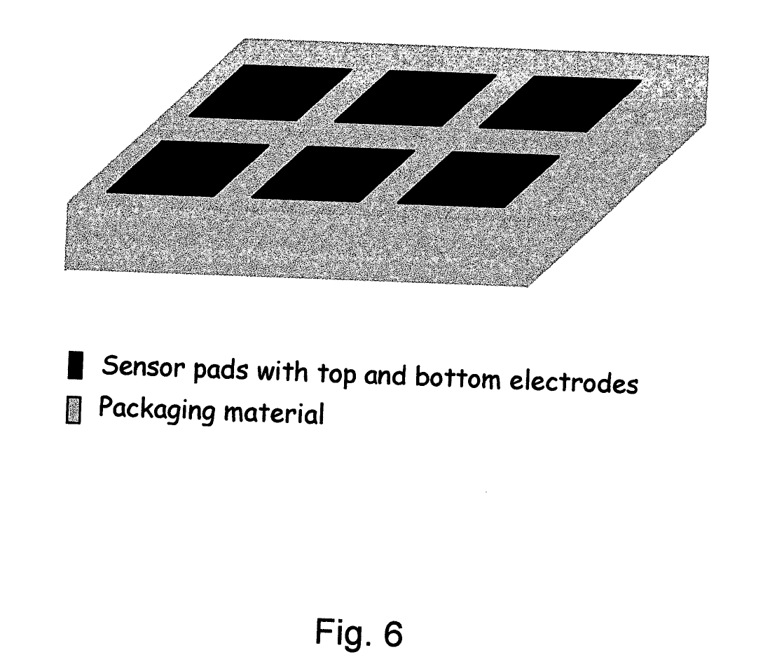

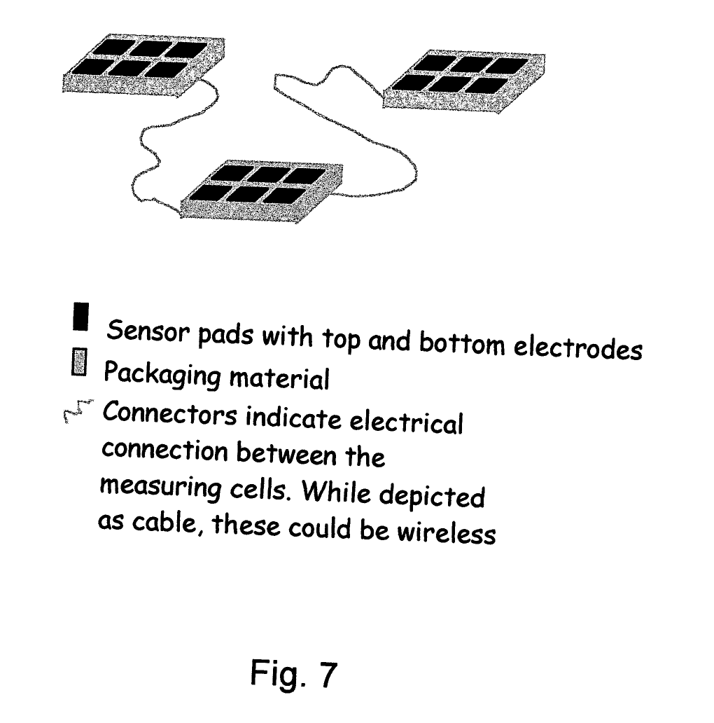

Different implementations of multiple measuring cells are shown in FIGS. 4 to 7. FIGS. 4 to 6 show different measuring cells configurations with flexible electrical traces and/or packaging materials whereas FIG. 7 displays multiple measuring cells connected through cable or wireless transmission. The size and number of individual cells is chosen depending on the application, from one for a food tray weighing device, to hundreds for a high precision chemistry weighing device. Depending on the application, these individual measuring cells can be either rigid or flexible. The electrical traces are in this case arranged so that the electrical signal is collected serially or in parallel through these measuring cells. The electrical signal, that is proportional to the overall deformation is computed. For example, for piezo-resistive measuring cells, the overall signal is computed taking advantage of the electrical addition of resistances in series or the addition of their conductance for resistances in parallel.

For weighing device applications aiming at weighing moving objects, the measuring cells may be designed such to produce instantaneous electrical signals, i.e. typically in the sub-second time range: The measuring cell is designed in a manner sufficient to allow measurements of the signal in a timeframe chosen such that each measurement may be considered as nearly steady-state. When the object is moving over the flexible weighing device, instantaneous electrical signals are recorded and computed through the board processing unit and displayed. The time average of the signal may be use to compute the overall weighing device signal. An example of such measuring cell would be piezo-resistive measuring cells. The measuring time may be set such that only a specific frequency range will contribute to the overall computed signal.

The weighing devices may optionally be packaged with an external packaging material, whose characteristics are either included in the correcting board processing unit or do not influence the weighing process. This external packaging material may form a protective packaging layer. For example, it would allow the apparatus to be protected from the environment (e.g. teflon coating for chemicals) while maintaining the overall flexibility of the device.

1. A flexible weighing device comprising:
a) at least one measuring cell, which cell yields an electrical signal proportional to its deformation;
b) a processing circuitry, which circuitry computes the overall signal resulting from the electrical signal from the at least one measuring cell; and
c) a display, which shows the overall signal computed by the processing circuitry.

2. The device of claim 1, wherein the at least one measuring cell is flexible.

3. The device of claim 1, wherein the at least one measuring cell is non-flexible.

4. The device of claim 1, wherein there are at least two measuring cells flexibly connected.

5. The device of claim 4, wherein the at least two measuring cells are flexible.

6. The device of claim 4, wherein the at least two measuring cells are non-flexible.

7. The device of claim 4, wherein at least one of the at least two measuring cells is non-flexible.

8. The device of claim 4, wherein at least one of the at least two measuring cells is flexible.

9. The device of claim 1, wherein the processing circuitry uses cable connections.

10. The device of claim 1, wherein the processing circuitry uses wireless connections

11. The device of claim 1, wherein the processing circuitry uses a combination of cable and wireless connections.

12. The device of claim 1, wherein the processing circuitry is integrated onto the said weighing device.

13. The device of claim 1, wherein the processing circuitry is separated from the said weighing device.

14. The device of claim 1, wherein the display is a visual display or an audio display.

15. The device of claim 1, wherein the display is flexible.

16. The device of claim 14, wherein the display is integrated onto the said weighing device.

17. The device of claim 14, wherein the display is separate from the said weighing device.

18. The device of claim 1, wherein the at least one measuring cell provides instantaneous signal.

19. The device of claim 1, wherein the measuring cell is constructed of a flexible resistive elastomer.

20. The device of claim 1, wherein the measuring cell is constructed of a flexible resistive elastomer embedded in a flexible insulating elastomer.

21. The device of claim 1, wherein the measuring cell is constructed of a piezo-resistive sensor.

22. The device of claim 1, wherein the measuring cell is constructed of a 1-dimensional (semi-)conductive elastomer.

23. The device of claim 4, wherein the at least one measuring cell is flexibly connected by a flexible insulating elastomer.

24. A method for measuring the weight of a moving object, said method comprising
1. providing on a surface a flexible weighing device comprising
a) at least one measuring cell, which cell yields an electrical signal proportional to its deformation,
b) a processing circuitry, which circuitry computes the overall signal resulting from the electrical signal from the at least one measuring cell, and
c) a display, which shows the overall signal computed by the processing circuitry,
wherein said measuring cell provides an instantaneous signal that is processed by the processing circuitry and shown on the display; and
2. moving said object over the flexible weighing device in a manner sufficient to allow the measuring cell to deform;
3. reading the weight shown on the display.
